(19) United States
(12) Patent Application Publication
(10) Pub. No.: US 2006/0143196 A1
(43) Pub. Date: Jun. 29, 2006

(54) Information generating apparatus and information generating method

(76) Inventors: Hideo Umeki, Yokohama-shi (JP); Tomoo Ikeda, Kawasaki-shi (JP); Sogo Tsuboi, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/289,690

(22) Filed: Nov. 30, 2005

(30) Foreign Application Priority Data
Nov. 30, 2004 (JP) 2004-346515

(51) Int. Cl. G06F 7/00

(52) U.S. Cl. 707/100

(57) ABSTRACT

A relation information generating apparatus includes a detecting unit configured to detect an action done by a user when the user creates or selects a first information resource referring to at least one second information resource, and a relation information generating unit configured to generate first relation information and second relation information according to the detected action and to impart the first relation information and the second relation information to the first information resource and the second information resource to correlate with each other, the first relation information including a first descriptive text to explain a relation from the first information resource to the second information resource, and the second relation information including a second descriptive text to explain a relation from the second information resource to the first information resource.

### CROSS-REFERENCE TO RELATED APPLICATIONS

This application is based upon and claims the benefit of priority from prior Japanese Patent Application No. 2004-346515, filed Nov. 30, 2004, the entire contents of which are incorporated herein by reference.

### BACKGROUND OF THE INVENTION

1. Field of the Invention

The present invention relates to a relation information generating apparatus to generate relation information indicating relation between a certain information resource and another information resource, and a method of generating the same.

2. Description of the Related Art

When a new information resource is created based on an information resource such as a document electronically saved or an E-mail, an existing information resource is reused by being watched, referred to or quoted. Till now, such relating between information resources is performed by one-sided reference such as referring to a source mail relating to a reply of an E-mail, for example, or a list of reference literatures mentioned in a document.

Further, it is done to manage a relation indicating an information resource of a partner in bidirection, for example, a list of other mails replied to a mail which a user is looking at now (by a mailing list control system, etc.), and a list (CiteSeer) of documents from which a certain document is quoted.

Further, there are a system referring to information of another Web page by a hyperlink of HTML used in a Web page of Internet, and a system referred to as a track back configured to write in a referred page a descriptive text and a hyperlink to a Web page on the side referring to the referred page, to the contrary.

On the other hand, Japanese Patent Laid-Open No. 2003-263462 discloses a technique of storing, in a storage device, link information representing a reference relation defined between electronic data in an information system to search the electronic data and additional information including a comment added to at least one of reference relations and user information with associating with each other, and reading out, from the storage device, link information and additional information that conform the search condition.

In the above prior art, how a certain information resource relates to another information resource to be referred to can be read only from fixed information such as a mail reply relation and a document reference relation. Therefore, it is difficult to grasp how a certain information resource relates to another information resource.

In a mail system or a document reading system, relationship between an information resource as an object and an information resource to be dealt with has only to be fixed information decided beforehand. However, in a knowledge management system to promote efficiency of organized intelligent production activity in a company, it is difficult to manage all of various kinds of information resources practically.

In such a knowledge management system, various information to be dealt with in organization or groups sharing a certain work must be shared with respective groups in view of how the information is created and how it is utilized. For this reason, as for a reference relation that a certain information resource refers to another information resource, there is considered a method of adding a term for explaining that it is an information resource including what kind of content as well as data indicating simply a location of the information resource of a partner such as URL. However, the term is created manually by a user oneself or uses a fixed term such as an “article of reply source”, an “origin of quoting”, an “following article”, “reference information”, “relation information” and “comment”. It is not possible to know detailed information such as process or evaluation concerning a certain information resource.

On the other hand, in a system creating an new information resource using a plurality of information resources and sharing these information resources, if a user registers an information resource such as a document or a message with a specific region of a computer on a network, and imparts an access right for accessing the region to a specific user group, the system has a function to share the information resource registered with the region. The information resources to be shared do not exist independently. For example, the content of a certain information resource is a comment such as an opinion for another information resource actually, or a summary of the contents of a plurality of other information resources, so that there is often some correlation between the information resources. However, only by indicating that there is some correlation, it is insufficient to grasp what relation exist between the information resources even if the information resource is referred.

It is difficult to grasp from one electronic data how respective electronic data relate to other electronic data by the technique of Japanese Patent Laid-Open No. 2003-263462. Also, it is difficult to grasp a clear reference relation because the comment oneself is input by a user.

It is an object of the invention to provide a relation information generating apparatus to generate relation information capable of grasping what relation exists between a criterion information resource and another information resource generated or selected based on the certain information resource, and a method of generating the same.

### BRIEF SUMMARY OF THE INVENTION

An aspect of the present invention provides a relation information generating apparatus of generating information indicating a relation between a plurality of information resources, the apparatus comprising: a detecting unit configured to detect an action done by a user when the user creates or selects a first information resource referring to at least one second information resource; and a relation information generating unit configured to generate first relation information and second relation information according to the detected action and to impart the first relation information and the second relation information to the first information resource and the second information resource to correlate with each other, the first relation information including a first descriptive text to explain a relation from the first information resource to the second information resource, and the second relation information including a second descriptive text to explain a relation from the second information resource to the first information resource.

### BRIEF DESCRIPTION OF THE SEVERAL VIEWS OF THE DRAWING

FIG. 1 is a diagram of a correlation link (relation information) generating apparatus according to an embodiment of the present invention.

FIG. 2 is a diagram showing a correlative link generated for one information resource.

FIG. 3 is a diagram showing a data structure inside the correlation link.

FIG. 4 is a diagram showing an action classification in a case of making a new information resource.

FIG. 5 is a diagram showing a adaptive example of utilization environment of an relation information generating apparatus.

FIG. 6 is a block diagram showing a configuration including a relation information generating apparatus according to an embodiment of the present invention.

FIG. 7 shows flowchart for explaining a process before generating relation information.

FIG. 8 shows flowchart for explaining an relation information generating process.

FIGS. 9A and 9B are diagrams for describing an action in a case of a single information source and a case of a plurality of information sources.

FIG. 10 is a diagram showing a login screen to an information sharing system site utilizing an information resource having a correlation link.

FIG. 11 is a diagram showing a link screen to a work group directory managed with an information shared system.

FIG. 12 is a diagram showing a list screen of an information resource made in a group directory.

FIG. 13 is a diagram showing a screen displaying detailed information on an information resource.

FIG. 14 is a diagram showing a work tray screen in a circumstance that an information resource is not selected.

FIGS. 15A and 15B are diagrams indicating items of selection of a group and items of types of an action.

FIG. 16 is a diagram showing a work tray screen in a circumstance that a plurality of information resources are selected.

FIG. 17 is a diagram showing an action execution screen which is displayed when an action collecting up contents is selected.

FIG. 18 is a diagram showing an action execution screen which is displayed when an action to evaluate is selected.

FIGS. 19A and 19B are diagrams for explaining an example of generating a correlation link.

FIGS. 20A and 20B are diagrams for explaining an example of generating a correlation link.

FIG. 21 is a diagram for explaining an example of displaying a plurality of information resources saved in a work tray.

### DETAILED DESCRIPTION OF THE INVENTION

There will now be described an embodiment of the present invention in conjunction with drawings.

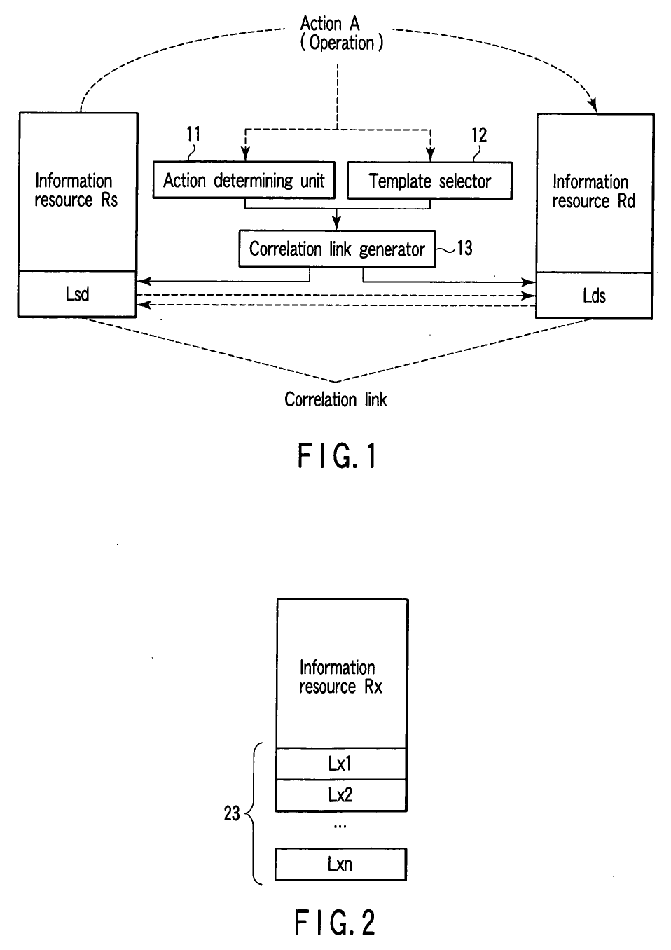

FIG. 1 shows a schematic diagram of a correlation link generating apparatus to generate a correlation link (relation information) between information resources according to an embodiment of the present invention. When another information resource Rd is created based on a certain information resource Rs, correlation links (relation information) Lsd and Lds are established according to an action A (operation) from one information resource to another information resource, and imparted to both information resources Rs and Rd.

There is explained preparation of correlation links Lsd and Lds hereinafter. At first an action determination unit 11 determines the content of the action A, and provides a determination result to a correlation link generator 13. A template selector 12 selects a template according to the action A and provides it to the correlation link generator 13. The correlation link generator 13 outputs correlation links Lsd and Lds to the information resources Rs and Rd respectively, according to the determination result and the template of the action.

The correlation links Lsd and Lds include an identifier indicating a location of another information resource relating to the certain information resource and a descriptive text describing what relation the another information resource has with respect to the certain information resource. Therefore, the relation that the another information resource referred to has with respect to the certain information resource can be grasped to some extent before reading the another information resource directly. On this occasion, the descriptive text of the correlation links Lsd and Lds is automatically created using at least one of (1) information indicating what action (operation) generates the information resource Rd from the information resource Rs, (2) information provided by comparison of content of the information resource Rs with that of the information resource Rd, and (3) information of caption concerning the information resource Rs included in the information resource Rd. This embodiment can be applied to a plurality of information resources Rs.

The correlation link between information resources will be described concretely hereinafter. Assuming that when a user does the action (operation) A on the basis of a certain information resource Rs, another information resource Rd is provided, as shown in FIG. 1. In this case, the correlation link Lsd is imparted to the information resource Rs and the correlation link Lds is imparted to the information resource Rd.

The correlation link is information concerning the information resource Rd with reference to the information resource Rs, and information concerning the information resource Rs with reference to the information resource Rd. In other words, the correlation link includes identification information for identifying an information resource of a partner, and a caption indicating what relation the information resource of the partner has with respect to an own information resource. If the action A is an action to “comment”, for example, the correlation link Lsd on the information resource Rs side which is provided by the action A stores a descriptive text representing that the information resource Rd is a “content of comment” to the own information resource Rs, along with identification information for identifying the information resource Rd provided as a result of the action A.

The correlation link Lds on the information resource Rd side stores information for explaining the information resource Rs, for example, a sentence meaning “object to be commented”, along with information indicating the information resource Rs.

As thus described, by generating the correlation links Lsd and Lds, and adding them to the information resources Rs and Rd respectively, it is possible to grasp from the correlative link what relation the own information resource has with respect to another information resource.

A correlative link added to a single information resource will be described hereinafter. FIG. 2 is a diagram indicating a correlation link generated with respect to a single information resource. Paying attention to a single information resource Rx as shown in FIG. 2, in the case that this information resource Rx affects a plurality of actions, correlation links Lx1 to Lxn are imparted to the information resource Rx every action. As a result, this information resource Rx comes to have a plurality of correlation links 23. Each of the correlation links Lx1 to Lxn stores identification information of the related information resource and information explaining the content thereof.

In this manner, if a correlation link is prepared every action with reference to a single information resource Rx, it is possible to grasp in detail a relation with another information resource and content thereof every action by referring to only the correlation link of the single information resource.

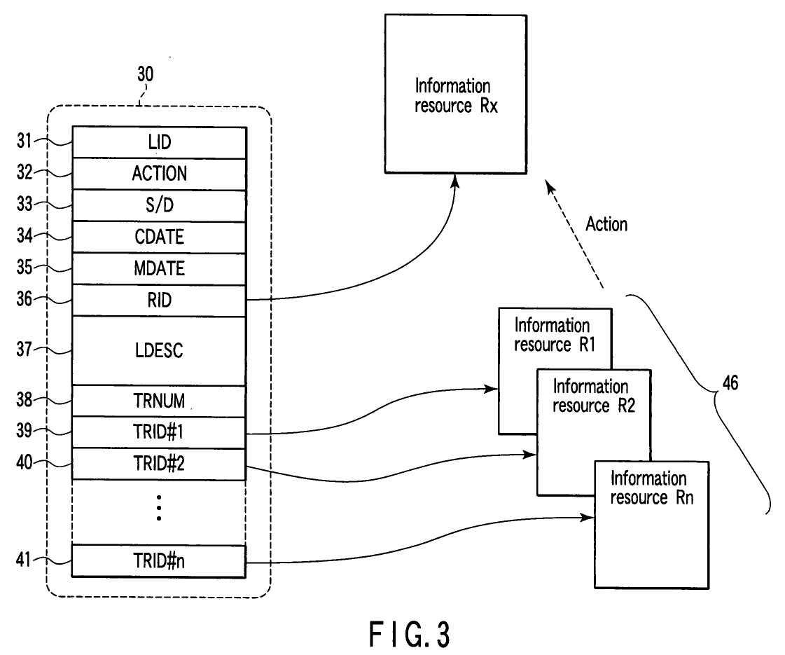

The data structure of the correlation link will be described in detail in conjunction with FIG. 3. When a new information resource Rx is obtained as a result in that a certain action is done by n information resources 46 including information resources R1, R2 . . . Rn, the correlation link 30 shown in FIG. 3 has a structure of the correlation link generated in association with the information resource Rx.

The correlation link 30 contains a LID region 31 storing ID to identify a correlation link, an ACTION region 32 storing an action of a correlation link, a S/D region 33 storing distinction of a source or a destination of a correlation link, a CDATE region 34 storing a correlation link creation date, a MDATE region 35 storing a last updated date and time of a correlation link, a RID region 36 storing ID of an information resource belonging to this correlation link, a LDESC region 37 storing a descriptive text of a correlation link, a TRNUM region 38 storing the number of information resources to be subjected to a correlation link, and a plurality of OTRID regions 39, 40 . . . 41 storing information resources ID to be subjected to a correlation link.

Also, correlation links similar to the above are generated on n information resource 46 containing information resources R1, R2 . . . Rn. With the information resources associated with each other by an action, source information resources and generated information resources allow relation of multiple to multiple. In this case, the correlation links are given for all relating information resources every action, and each contains identification information for identifying information resource of a partner and content caption thereof.

The correlation link 30 of such a structure makes it possible to grasp relation with another information resource and content thereof in detail, only by referring to relation information generated by the information resource.

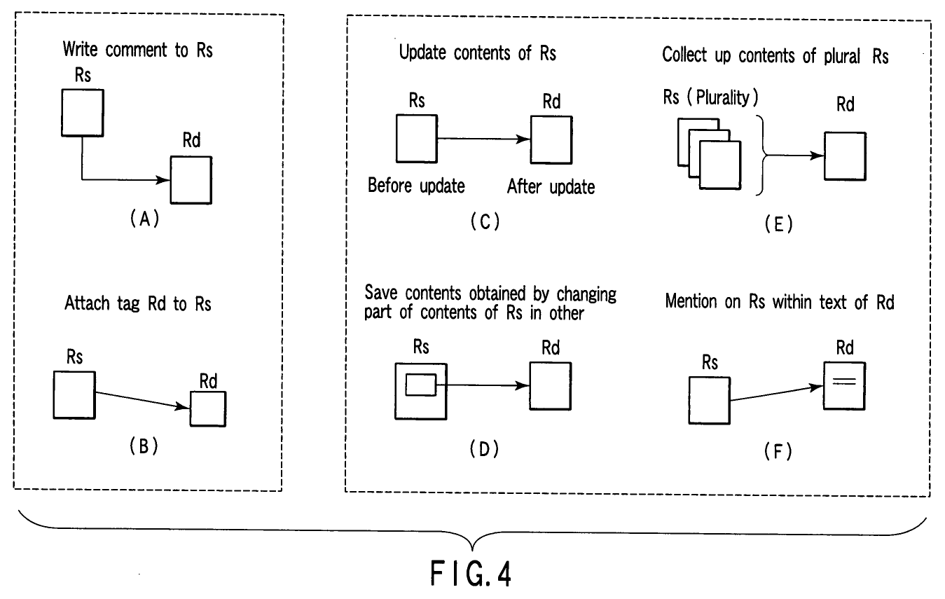

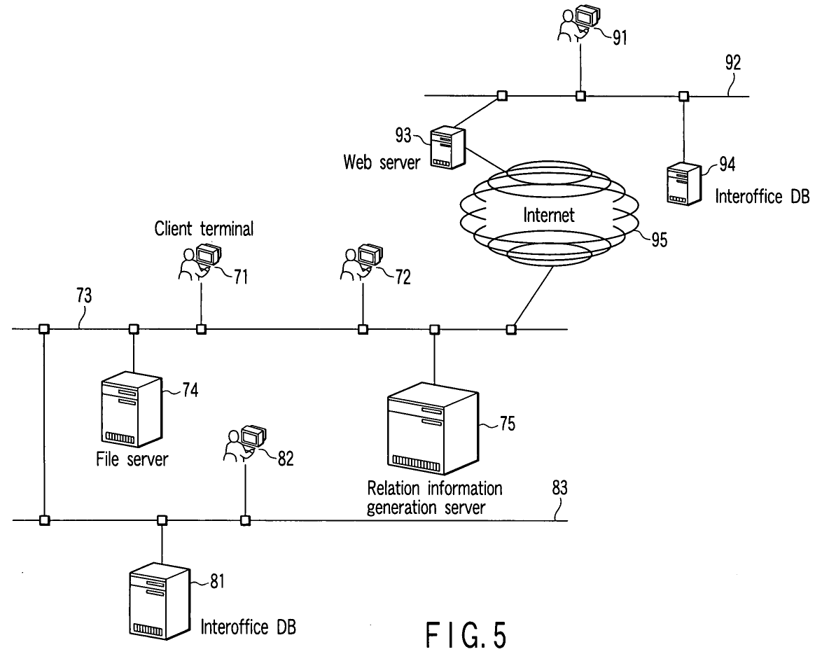

There will be described actions (operations) when preparing new information resource referring to information resource in conjunction with FIG. 4. FIG. 4 is a diagram showing classification of actions when preparing a new information resource. FIG. 4 (A) shows an action to write a comment (opinion) to the information resource Rs, FIG. 4 (B) shows an action to touch a tag of an information resource Rd to the information resource Rs, FIG. 4 (C) shows an action to update a content of the information resource Rs, FIG. 4 (D) shows an action to save a content obtained by changing a part of the content of the information resource Rs in other, FIG. 4 (E) shows an action to collect up the contents of a plurality of information resources Rs, and FIG. 4 (F) shows an action to mention the information resource Rs in the text of the information resource Rd.

The actions of FIG. 4 (A) and FIG. 4 (B) receive the source information resource Rs, and are classified as an action to make an information resource including a content to supplement the content (refer an action of this classification to as a flow in the sense of “flow of a topic”). The actions of FIG. 4 (C) to FIG. 4 (F) are classified as actions to make a new information resource using a part or all of the source information resource (refer an action of this classification to as a stock in the sense of “stock in another form”).

As thus described, it is possible to make a correlation link including a detailed caption such as what relation the relation information resource has or what content it has, according to each classification of respective actions.

Further, it is possible to do these actions for a plurality of selected information resources Rs, and to make a correlation link between the information resource Rd generated by the action and the information resource Rs as a source of the information resource Rd.

The embodiment is not limited to the actions shown in FIG. 4, and can be applied to another action such as an action to make a list of contents by extracting a specific content of each information resource Rs or an action to write a message with an attached file.

There will be described an environment to use a relation information generating apparatus to generate a correlation link (relation information) hereinafter. FIG. 5 is a diagram showing an example of a utilization environment of the relation information generating apparatus. As shown in FIG. 5, an information generation server 75 executes a process of generating relation information through networks 92, 83 and Internet 95. The server 75 is accessed by software of a Web browser of a plurality of client terminals 71, 72, 82 and 91 through networks 83, 92. The data of the information resource can utilize data existing inside the relation information generation server 75 or on a file server 74 on Intranet, in-house databases 81, 94 or a Web server 93 accessible on the Internet 95. The relation information generating apparatus can generate relation information in a client terminal or a server terminal without limiting to utilization environment shown in FIG. 5.

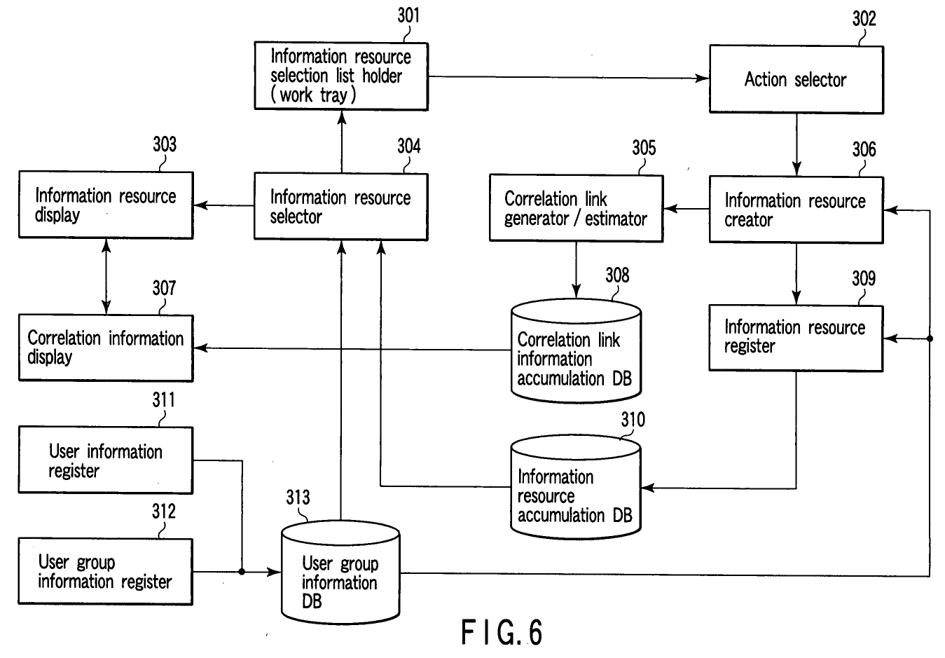

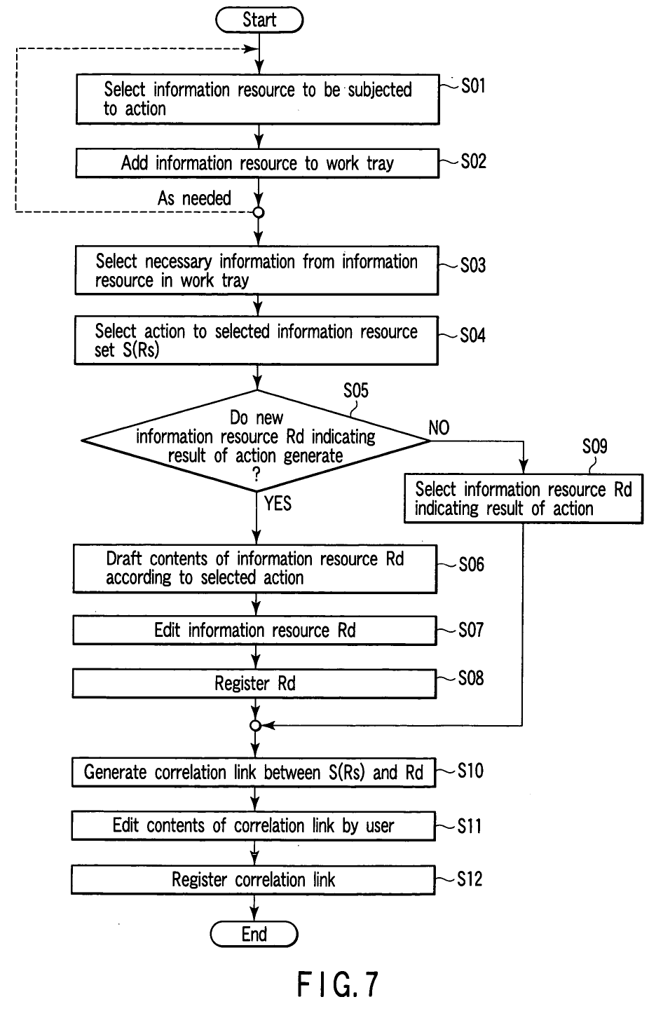

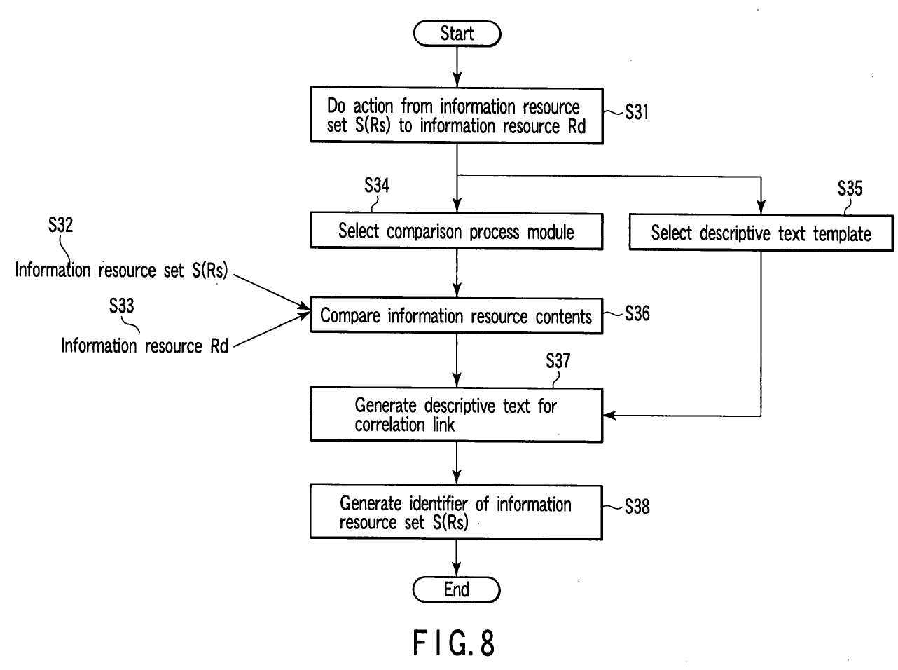

There will be explained configuration and a generating process of the relation information generating apparatus. FIG. 6 is a block diagram which shows a configuration of a relation information management apparatus including the relation information generating apparatus showed in FIG. 1. FIG. 7 is flowchart for explaining a process before generating relation information. FIG. 8 is flowchart for explaining a relation information generating process.

A relation information generating process will be described referring to flowcharts of FIGS. 7 and 8 and the block diagram of FIG. 6 hereinafter. The relation information generating apparatus shown in FIG. 6 is an apparatus for generating relation information according to each information resource. As shown in FIG. 7, at first an information resource display unit 303 displays an information resource to be subjected to an action to make a user select the displayed information resource with an information resource selector 304 (step S01). For example, a button “adding to a work tray” is displayed and selected by a user. The information resource selector 304 adds ID (identifier) of the information resource to an information resource selection list holder (work tray) 301, referring to a user group information DB 313 and an information resource storage DB 310 according to the selected button (step S02). As a result, it is possible to collect a plurality of information resources necessary for the work tray.

When the user requests to register user information and user group information of the user group information DB 313, they are stored in a user information register 311 and a user group information register 312. After the process of step S02, steps S01 and S02 are repeated as needed.

An action selector 302 selects an information resource necessary as the source information resource from the information resources collected to the information resource selection list holder (work tray) 301 (step S03). The user selects an action to a set S(Rs) of selected information resources with the action selection unit 302 (step S04). When an action is selected, an information resource creator 306 determines whether a new information resource should be created (step S05).

When creation of the new information resource is determined, the information resource creator 306 uses a draft content of the information resource Rd according to the selected action (step S06). In the case of an action to “comment”, for example, the content of the source information resource Rs is quoted with a quote mark in the text of the information resource to be created. In the case of an action to “collect up contents”, it is considered to combine the contents obtained by removing unnecessary parts such as greetings sentence and a signature from contents of a plurality of source information resources, and insert the combined content into the information resource as a text.

After step S06, the information resource creator 306 edits the information resource Rd according to a user request (step S07). An information resource register 309 registers the information resource Rd with the information resource storage DB as a result of the action (step S08). When it is determined in step S05 not to create a new information resource, the information resource creator 306 selects the information resource as a result of the action referring to a user group information DB 313 (step S09).

A correlation link generator/estimator 305 generates a correlation link between the new information resource Rd and the information resource S(Rs) (step S10). This process will be described referring to FIG. 8 in detail. The correlation link generator/estimator 305 edits the content of the correlation link generated according to the user request (step S11). The correlation link generator/estimator 305 registers the edited correlation link with the correlation link information storage DB 308 (step S12).

By generating a correlation link according to an action of an information resource made newly as described above, it is possible to grasp relation of the correlation link with the relating information resource and content thereof in detail.

The correlation link generating process will be described hereinafter. As shown in FIG. 8, at first the correlation link generator/estimator 305 receives an action from the information resource set S(Rs) to the information resource Rd, from the information resource creator 306 (step S31). The correlation link generator/estimator 305 selects a comparison module from a plurality of comparison modules according to the action, the comparison modules being prepared in the correlation link generator/estimator 305 (step S34). Further, the correlation link generator/estimator 305 selects a descriptive text template from a plurality of descriptive texts according to the action, the descriptive tests being prepared in the correlation link generator/estimator 305 (step S35). The correlation link generator/estimator 305 acquires the information resource set S(Rs) (step S32) and the information resource Rd (step S33) from the information resource creator 306, and compares those information resource contents with each other with a comparison processing module (step S36). The correlation link generator/estimator 305 generates a correlation link descriptive text according to a comparison result of information resource contents using the selected descriptive text (step S37). At the same time, the correlation link generator/estimator 305 generates an identifier of the information resource set S (step S38).

A purpose of a correlation link generating process shown in flowchart of FIG. 8 and step S10 of FIG. 7 is to generate a descriptive text of a correlation link to an information resource Rd obtained by a certain action and an source information resource (or source information resources) Rs behind the information resource Rd, the correlation link indicating that one information resource includes a content of what relation with the other from respective viewpoints. This descriptive text of the correlation link is generated on the basis of a comparison result of a comparison process done according to the action as described above. The correlation link generating process will be described using a concrete example hereinafter.

At first an action will be described. Two types of actions are explained in FIG. 4, and an concrete example in case of more than two types of actions will be described hereinafter. A user assumes the following actions as concrete action names selectable for the information resource. A1: write a comment, A2: attach a tag, A3: update, A4: collect up contents, and A5: refer to. The actions belong to action classes indicating types of actions respectively. The action classes assume four types of “topic”, “classification”, “update” and “aggregation”. The action classes are assumed to correspond to A1: write a comment “topic”, A2: attach a tag “classification”, A3: update “update”, A4: collect up contents “aggregation”, and A5: refer to “aggregation”. By classifying the actions in this way, it is possible to provide how to do browsing that serves one's purpose, for example, browsing the information resource while following the topic or browsing from most collected information.

The comparison process will be described hereinafter. When the source information resource Rs and the information resource Rd generated newly by an action are compared with each other, how the comparison process is done and what descriptive text is created are previously determined by respective actions. In the case of an action to “write a comment”, for example, a comparison module referred to as “comment comparison” is used, and the body of the descriptive text is generated by applying the comparison result to a “descriptive text template for comments”.

When the new information resource Rd is generated based on the source information resource Rs, a process content of “comment comparison” is executed in order of the following steps.

1. Delete a quoting part, greetings sentence and signature part of the new information resource Rd.

2. Determine whether the content remaining without being deleted in 1 is an “affirmative comment” or a “critical comment”.

As a result, a template for the descriptive texts is assumed to be set to (1) Rs→Rd: “ooo comment for this content” and (2) Rd→Rs: “information directed to this comment”, with reference to descriptive texts of the new information resource Rs viewed from the original information resource Rs and the source information resource Rs viewed from the new information resource Rd.

As for (1) ooo, when it is determined by a comparison process that an affirmative language is included in the information resource Rd, a word of “affirmative” is inserted in a location equal to (1) ooo. If the result of the comparison process indicates a critical comment, a word of “criticism” is inserted in the location. Accordingly, it is possible to generate, for example, Rs→Rd: an “affirmation comment to this content” as a correlation link descriptive text. The user can edit this manually.

Further, in a case of another action A4: “collect up contents”, the comparison process determines whether the content of the new information resource Rd reflects a part of the source information resource Rs with how much quantity. The template of the corresponding descriptive text comes to have a form of Rs→Rd: a “summary that oo of this content is reflected”. As a result, it is possible to generate a descriptive text of, for example, Rs→Rd: “summary that about 70% of this content are reflected” by inserting a digit value, etc. in the template in form of matching the result of the comparison processing with this oo.

As thus described, by generating and storing a correlation link whenever a new information resource is generated, it is possible to browse a detail content of the relating information resource, etc. from one information resource without browsing the relating information resource directly to display an information resource based on relation information.

Further, when a new information resource is created by the information resource creator 306 shown in FIG. 6, it is possible not only to create the new information resource as the process of step S05 shown in FIG. 6, but also designate an existing information resource as an information resource to be provided as a result of an action. For this reason, a given correlation link can be generated between the information resources that are already created.

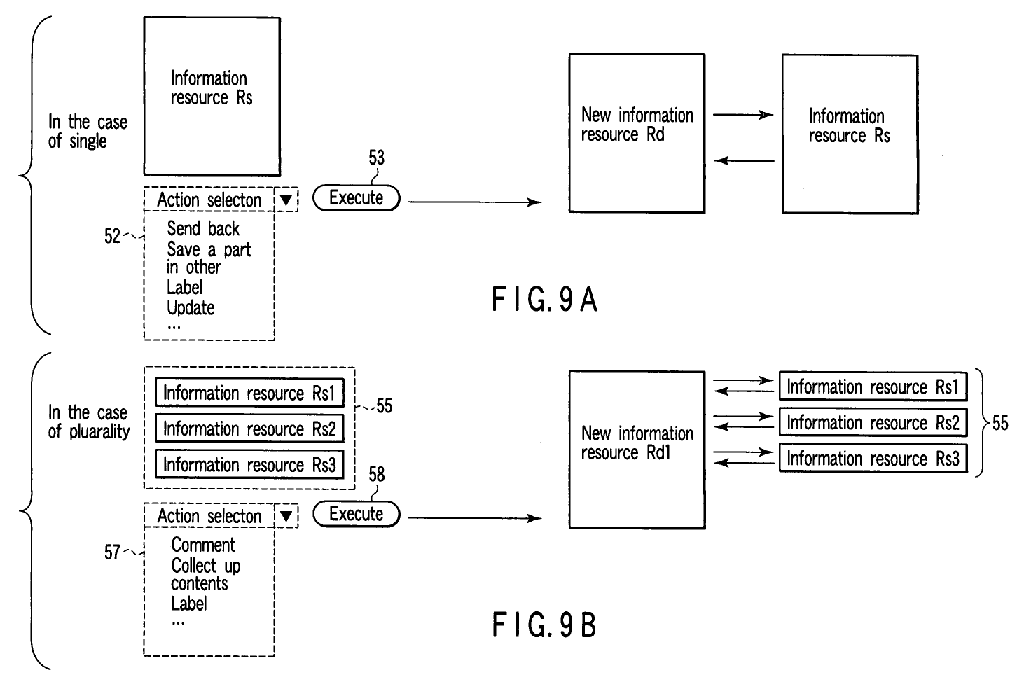

There will be described an example that the action varies according to an information resource. FIGS. 9A and 9B are diagrams for explaining an action of a single information resource and an action of plural information resources, respectively. FIG. 9A shows an action of a single source information resource Rs, and FIG. 9B shows an action of plural source information resources (1, 2 . . . ). When a new information resource Rd is generated for one information resource R as shown in FIG. 9A, a selection area 52 for selecting an action and an execution button 53 of an action are displayed on the display of a client terminal. When an inverted triangle button on a rightmost edge is clicked, the selection area 52 for action selection displays items “replying”, “commenting”, “updating”, “saving a part in other”, “labeling”, etc. When the user selects any one of the items displayed on the display area 52, and clicks the execution button 53, the new information resource Rd is created as a selection action result.

When a new information resource Rd1 is generated for a plurality of source information resources Rs (1, 2 . . . ) 55, a selection area 57 for action selection and an execution button 58 are displayed as shown in FIG. 9B. “Comment”, “Collect up contents”, “Label” are displayed on the selection area 57 for action selection. When the user selects any one of actions of the selection area 57 for this action selection, and clicks the execution button 58, the new information resource Rd1 is created as a result of the selected action.

If selectable actions are displayed according to the number of source information resources (or type thereof) as described above, the user can select an action to comply with each information resource.

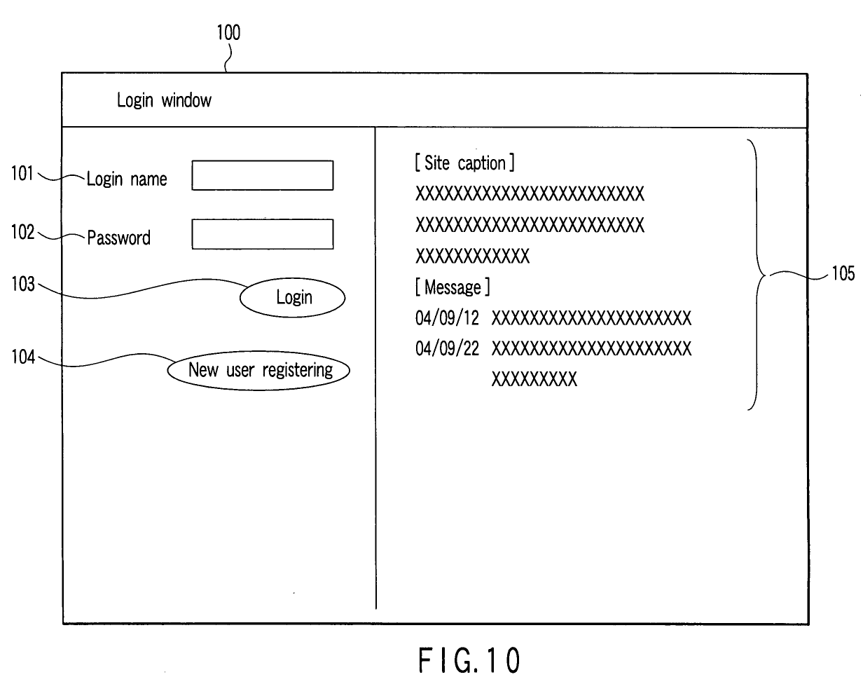

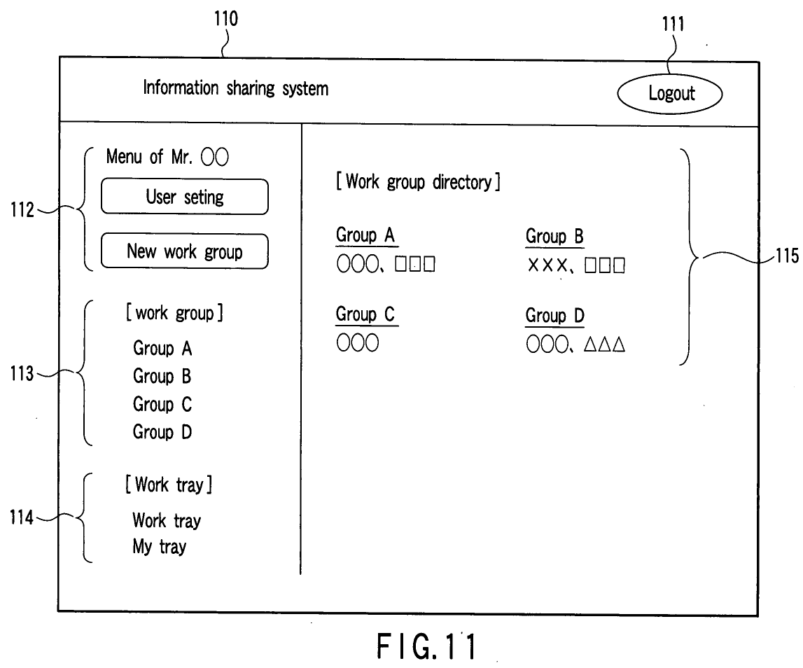

There will be described a screen for displaying on a client terminal a site that an information sharing system manages, the information sharing system having a relation information generating function utilizing an information resource having the above mentioned correlation link. FIG. 10 is a diagram showing a login screen for logging into an information sharing system site utilizing the information resource having the correlation link. A login screen 100 is a screen for logging into the site, which is requested from the client terminal to the information sharing system. The login screen 100 shown in FIG. 10 displays an input area 101 for inputting a login name, an input area 102 for inputting a password, a login button 103 for requesting a login, a new user registration button 104 for registering newly a user when the user is not registered, and a display area for displaying a message such as a caption of the site and an update history of the site. When the user inputs a login name and a password into the input areas 101 and 102 respectively, and selects the login button 103, the link screen 110 is displayed as shown in FIG. 11.

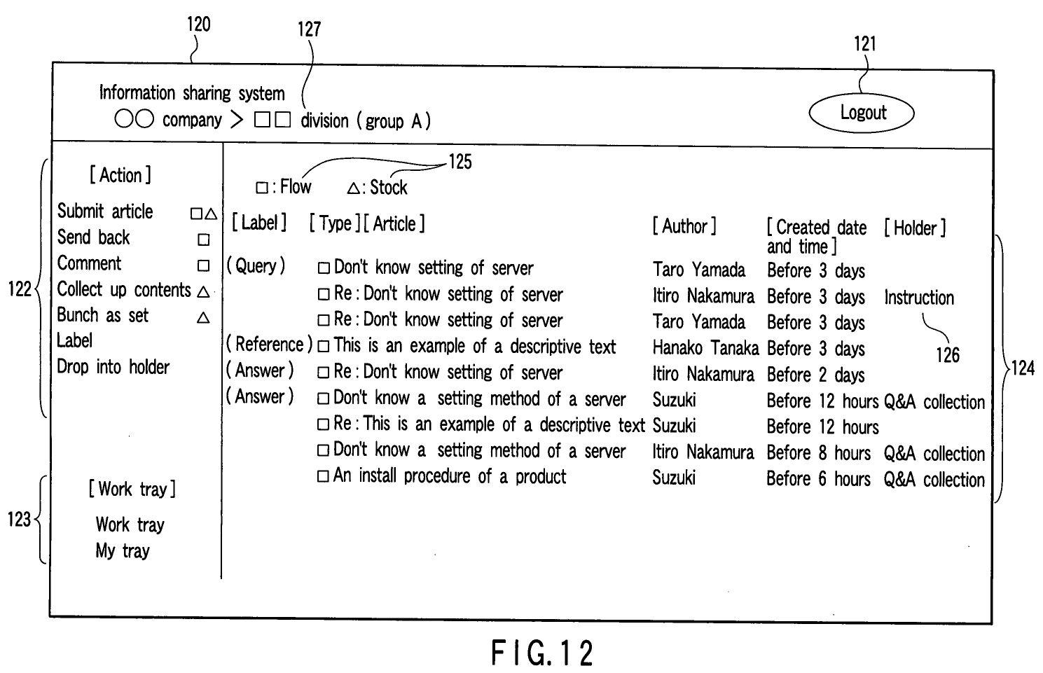

There will be explained the link screen 110 of FIG. 11 that is displayed after the login is carried out on the login screen 100. A selection area 112 for selecting an operable item, a selection display area 113 showing a list linking to each of work groups, a selection display area 114 showing a link to a work tray, a selection display area 115 for selecting a work group directory (groups A-D), and a button 111 for logging out are displayed on the link screen 110. The selection area 112 has a setting item to be changed by the user and an item for generating a new work group. When the user selects and clicks the group A of the selection display area 113 or the group A of the selection display area 115 with a mouse, a screen 120 of a list of information resources generated in the group A is displayed as shown in FIG. 12.

A list screen of information resources generated in a group directory is described in conjunction with FIG. 12 hereinafter. The list screen 120 of FIG. 12 displays a display area 127 showing a displayed list of directories, a selection display area 122 displaying a list of execution results of respective actions, a selection display area 123 showing a link to a work tray, a selection display area 124 displaying a list of information resources of the selected work group, a display area 125 showing a type of an action of each information resource (assuming that a symbol □ indicates a “flow”, and a symbol Δ indicates a “stock” as shown in FIG. 4), and a button 121 for logging out.

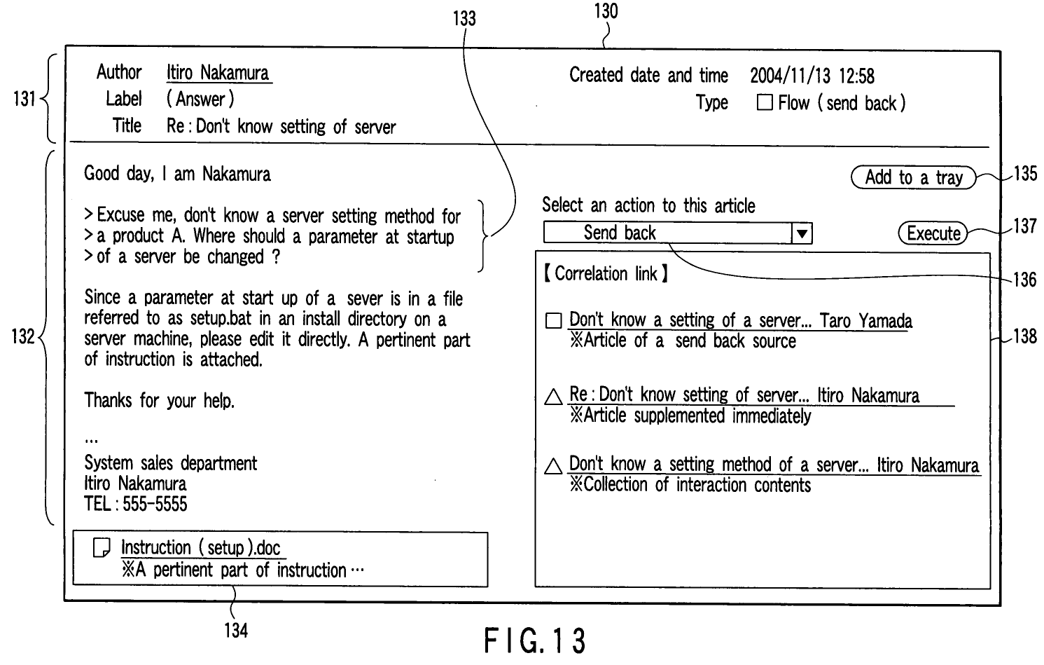

The symbol of an action type corresponding to each action is displayed along with the content of the action on the selection display area 122. The selection display area 124 displays an item of a label showing the content of an information resource, an item showing a type of an action, an item showing a title of an article, an item showing an author name who created the information resource, an item showing created date and time, and an item showing a folder name in which an information resource serving as a reference for the created information resource is stored. This selection display area 124 displays an information resource 126 including a label “question”, a type “□ (flow)”, article “Re: Don't know server setting”, author “Ichiro Nakamura”, created date and time “before 3 days”, and folder “instruction”. When this information resource 126 is selected, the screen 130 shown in FIG. 13 is displayed.

A screen showing detailed information of the information resource 126 shown in FIG. 12 is described in conjunction with FIG. 13 hereinafter. The screen 130 shown in FIG. 13 displays a display area 131 for displaying information similar to a list of the information resources 126 shown in FIG. 12, a display area 132 for displaying the content of the information resource, a selection display area 134 linked to an information resource to be referred, a button 135 added to a tray saving an information resource, a selection area 136 for selecting an action, a button 137 for executing the selected action, and a selection display area 138 linked to a relating information resource based on a correlation link.

The display area 132 displays a quoted passage 133 of a source information resource. This quoted passage 133 is a sentence quoted by “Don't know setting of server . . . Taro Yamada ※ Article of a send back source” of the type □ (flow) so as to be displayed on the correlation link of the selection display area 138. The selection display area 138 displays a type of a relating information resource, a title, an author and a descriptive text of a correlation link. An action selectable on the selection area 136 is selected according to what type the information resource to be selected is, as shown in FIG. 9.

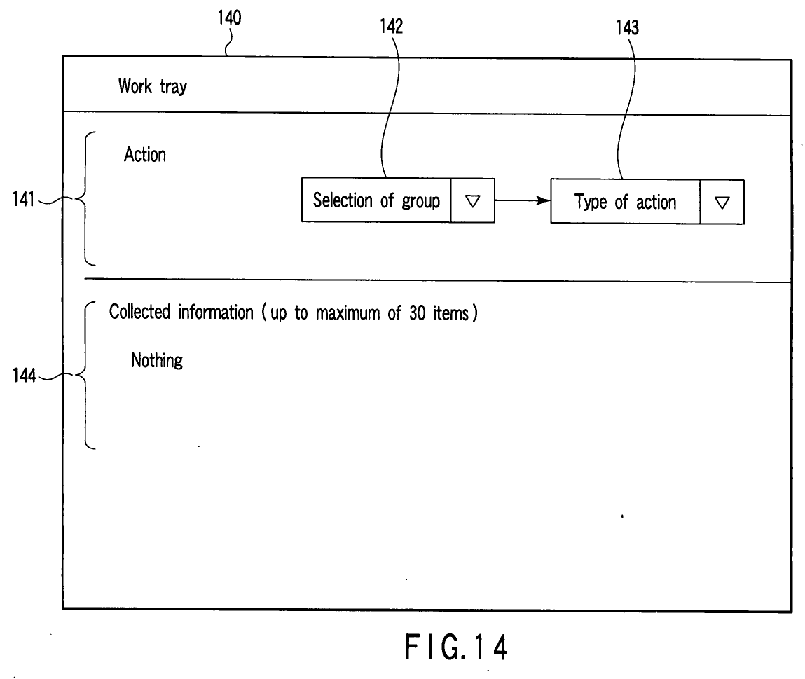

The work tray screen displayed when selecting a work tray of the selection display area 114 shown in FIG. 11 is described in conjunction with FIG. 14 hereinafter. The work tray screen 140 shown in FIG. 14 displays a display area 141 for displaying an information input zone necessary for an action, a selection area 142 for selecting a group, a selection area 143 for selecting a type of an action, and a display area 144 for displaying information resources collected in a work tray. The display area 144 displays an information resource added to a tray by selecting the button 135 shown in FIG. 13.

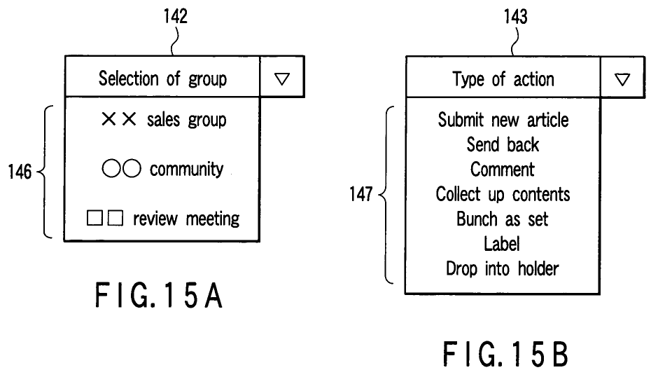

Each item of the selection area 142 for selecting a group and the selection area 143 for selecting a type of an action, which are shown in FIG. 14 is described in conjunction with FIGS. 15A and 15B hereinafter. If an inversed triangle on the rightmost edge of the selection area 142 shown in FIG. 15 (A) is selected, items of “XX sales group”, “oo community” and “□□review meeting” are displayed. Similarly, when an inversed triangle on the rightmost edge of the selection area 143 shown in FIG. 15B is selected, items 147 of “Submit new article”, “Send back”, “Comment”, “Collect up contents”, “Bunch as set”, “Label”, “Drop into holder” are displayed. The item of the selection area 143 of FIG. 15B is changed according to information resources collected in the work tray.

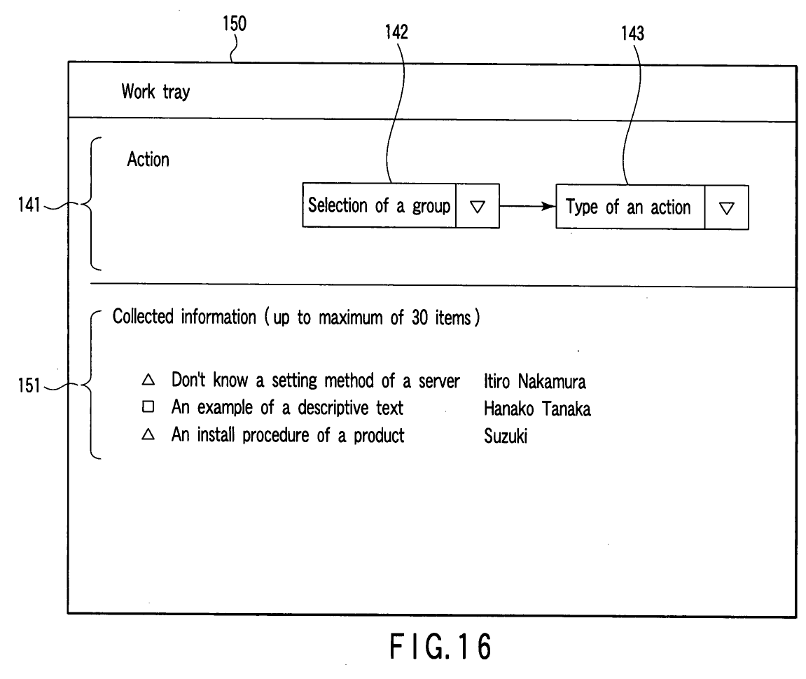

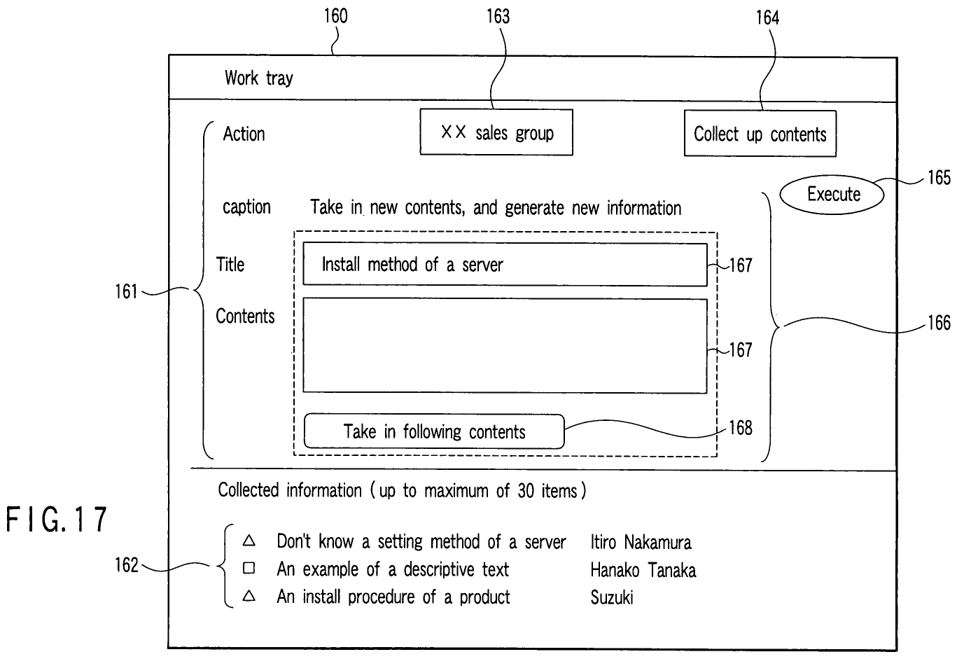

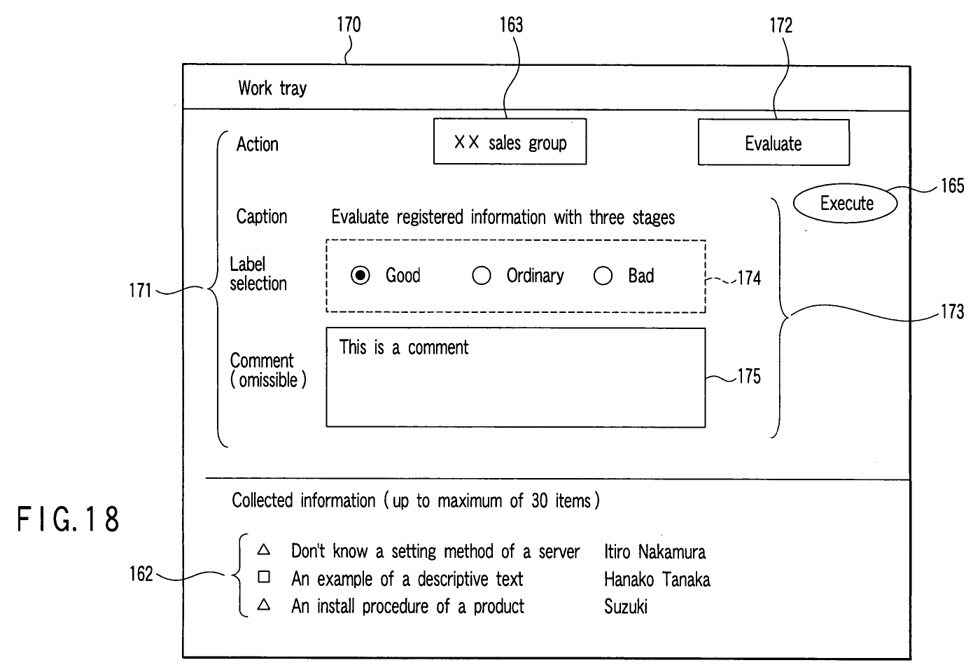

A work tray screen indicating a work tray saving the information resource is described in conjunction with FIG. 16 hereinafter. FIG. 16 shows a work tray screen 150 under the circumstance that a plurality of information resources are selected, and like reference numerals are used to designate like displayed items corresponding to those like in the work tray screen 140 of FIG. 14 and any further explanation is omitted. The display area 151 displays a plurality of information resources saved in the word tray from among a list of information resources displayed on the selection display area 124 of FIG. 12. When an action is selected from the selection area 143 with the information resources being saved in the work tray, action execution screens 160 and 170 shown in FIGS. 17 and 18 are displayed. A check box for deleting the selected information resource from the work tray may be provided on this display area 151.

An example to execute an action to the information resource of the work tray shown in FIG. 16 will be described in conjunction with FIGS. 17 and 18. FIG. 17 is a diagram showing an action execution screen displayed when selecting an action for collecting up contents. The action execution screen 160 shown in FIG. 17 displays a display area 161 for displaying an information input zone necessary for an action and a display area 162 for displaying the information resources collected up in the work tray. The display area 161 displays a selection area 163 for selecting a group, a selection area 164 for selecting a type of an action, and a button 165 for executing a selected action, and an input area 166 for editing according to an action. If the selection area 164 indicating an action to “collect up contents” is selected from the action execution screen 160, an input area 166 is displayed.

The input area 166 displays a caption of an action, an input area 167 for inputting a title and the content of a new information resource, and a button 168 for taking in the information resource displayed on the display area 162. When the user inputs an item on the input area 166 and then selects the button 165 for executing an action, a new information resource and a relation link having a descriptive text of an action in which contents are collected up are generated. At the same time, a correlation link is generated for each of a plurality of information resources related to the information resource.

FIG. 18 shows an action execution screen 170 displayed when selecting an action to evaluate, like reference numerals are used to designate like displayed items corresponding to those like in the action execution screen 160 of FIG. 17 and any further explanation is omitted. In the action execution screen 170, when the selection area 172 indicating an action to “evaluate” is selected, the input selection area 173 used for executing the action to evaluate is displayed. The input selection area 173 displays a caption of an action, a selection area 174 for selecting a label showing a result of evaluation of a new information resource, and an input area 175 for inputting a comment of the new information resource.

When a user selects a label and inputs a comment on the input selection area 173, and then clicks the button 165 for executing an action, a new information resource and a relation link having a descriptive text including an evaluation result are generated. At the same time, a correlation link is generated for each of a plurality of information resources related to the information resource.

When the action is executed via the action execution screens 160 and 170 of FIGS. 17 and 18 as described above, a descriptive text of a correlation link is created according to the action. As a result, it is possible to grasp the content of a relating information resource from one information resource in detail.

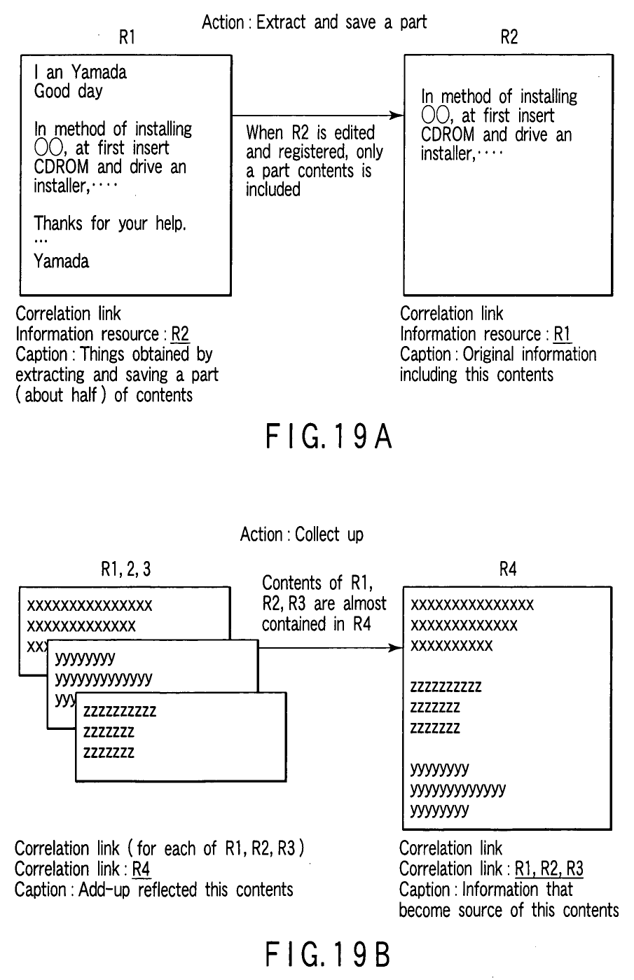

A concrete example of an action for a new information resource will be described in conjunction with FIGS. 19 to 21. FIGS. 19A and 19B are diagrams for explaining an example of generating a correlation link. In FIG. 19A, a new information resource shows an action to “extract and save a part” of one information resource. When a part of a source information resource R1 is extracted and saved in the new information resource R2, a correlation link having information (here, R2) for identifying the information resource R2 relating to the source information resource R1 and information explaining concretely a content referred to by the information resource R2 (i.e., information obtained by extracting and saving a part (about one-half) of contents) is generated and imparted to the source information resource R1. A correlation link having the information (R1) for identifying the information resource R1 relating to the new information resource R2 and information explaining the information resource R1 (source information including the content) is generated and imparted to the new information resource R2.

In FIG. 19 (B), the new information resource shows an action to “collect up” a plurality of information resources. When the new information resource R4 is created so as to contain almost every contents of a plurality of original information resources R1 to R3, a correlation link having information (R4) for identifying the information resource relating to the source information resources R1-R3 and information explaining concretely a content referred to by the information resource R4 (summary reflecting the content) is generated and imparted to each of the source information resources R1 to R3. A correlation link having the information (R1, R2, R3) for identifying information resources R1 to R3 relating to the new information resource R4 and information explaining the information resources R1 to R3 (information being a source of the content) is generated, and imparted to the new information resource R4.

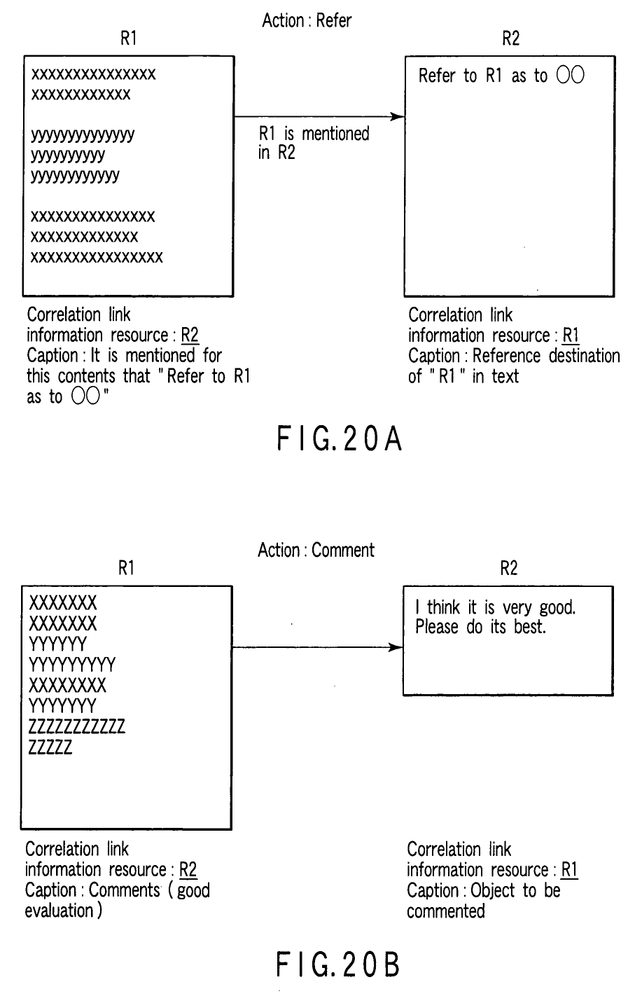

An example of generating a correlation link is described in conjunction with FIGS. 20A and 20B hereinafter. In FIG. 20A, the new information resource shows an action to “refer to” one information resource. When a new information resource R2 refers to the source information resource R1, a correlation link having information (R2) for identifying the information resource R2 relating to the source information resource R1 and information explaining a content mentioning the information resource R2 (mentioning “Refer to R1 as to oo” about the content) is generated and imparted to the source information resource R1. A correlation link having information (R1) for identifying the information resource R1 relating to the new information resource R2 and information explaining the information resource R1 (reference destination of text “R1”) is generated and imparted to the new information resource R2.

In FIG. 20B, the new information resource shows an action to “comment” on one information resource. When the new information resource R2 is the comment of the source information resource R1, a correlation link having information (R2) for identifying the information resource R2 relating to the source information resource R1 and information (comment (good evaluation)) indicating the content and evaluation of the information resource R2 is generated, and imparted to the resource information resource R1. A correlation link having information (R1) for identifying the information resource R1 relating to the new information resource R2 and information explaining the information resource R1 (object to be commented) is generated and imparted to the new information resource R2.

As thus described, if a correlation link having identification information of a relating information resource and information concerning a content caption corresponding to an action is generated for each of information resources, it is possible to grasp a detail content directly from the correlation link of a certain information resource without browsing the relating information resource.

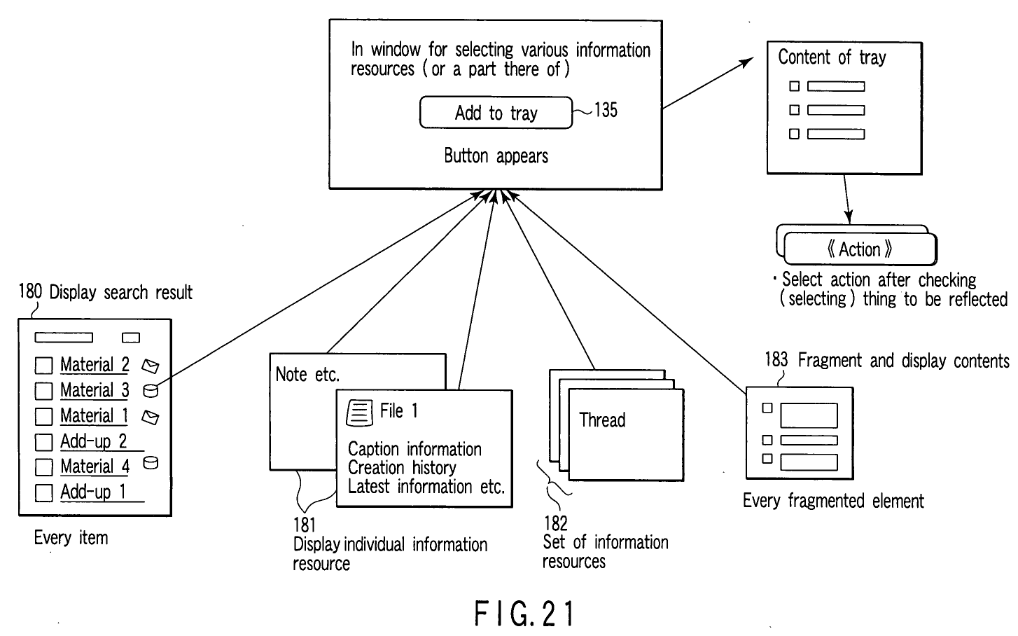

An example of displaying a plurality of information resources saved in a work tray when a plurality of information resources are selected will be described referring to FIG. 21. In FIG. 21, when a new information resource is generated by executing an action, a screen for selecting various source information resources (or a part thereof), for example, a screen 130 shown in FIG. 13 displays a button 135 for adding the selected information resource to the work tray. When a plurality of information resources are saved in the work tray, they are displayed on a screen for displaying a list of the contents of the work tray (work tray screens 140, 150, 160 and 170 of FIG. 14 and FIGS. 16 to 18) is displayed. A user selects from the list an information resource to make a new information resource reflect, and selects an action further. In this time, a correlation link is imparted to the information resource.

The information resources saved in the work tray are displayed as a search result display 180 every item, an individual information resource display 181 of information resources such as descriptive information, a creation history and latest information, and a fragmented content display every fragmented element, or saved as an information resource set 182 of threads. The user selects a plurality of information resources which are displayed and saved, and select an action to execute it.

As described above, when an action is executed, it is possible to display relation information between information resources to support the action such as information on search results and information resources thereof, using a correlation link of a plurality of information resources selected.

The relation information generating process explained in the embodiment can be realized by hardware or executed in software with a computer. In other words, according to the present invention, there is provided a computer readable medium storing a program for causing a computer to execute a process of determining an action to be used when a user creates or selects a second information resource referring to at least one first information resource, and a process of generating first relation information including a first descriptive text to explain relation of the second information resource with respect to the first information resource according to the determined action and second relation information including a second descriptive text to explain relation of the first information resource with respect to the second information resource.

According to the present invention, if relation information added to an information resource is referred to, it is possible to grasp what relation the information resource has with another information resource before browsing the another information resource directly. Also, it is possible to obtain a process that the information resource is generated, evaluation of the relation information resource, and latest information by referring to this relating information.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A apparatus of generating information indicating a relation between a plurality of information resources, the apparatus comprising:
a detecting unit configured to detect an action done by a user when the user creates or selects a first information resource of the plurality of information resources referring to at least one second information resource of the plurality of information resources; and
a relation information generating unit configured to generate first relation information and second relation information according to the detected action and to impart the first relation information and the second relation information to the first information resource and the second information resource to correlate with each other, the first relation information including a first descriptive text to explain a relation from the first information resource to the second information resource, and the second relation information including a second descriptive text to explain a relation from the second information resource to the first information resource.

2. The apparatus according to claim 1, further comprising a storage to store the first relation information and the second relation information correlating with the first information resource and the second relation information respectively.

3. The apparatus according to claim 1, which further comprises a template selector unit configured to have a plurality of templates corresponding to a plurality of actions and select a template from the templates according to the detected action, and wherein the relation information generating unit is configured to generate the first descriptive text and the second descriptive text using the selected template.

4. The apparatus according to claim 1, wherein the first relation information includes an identifier indicating a location of storing the second information resource, and the second relation information includes an identifier indicating a location of storing the first information resource.

5. The apparatus according to claim 1, wherein the relation information generating unit is configured to generate the first descriptive text and the second descriptive text using at least one of a content of the action, information provided by comparison between the first information resource and the second information resource and a caption relating to the second information resource, which is contained in the first information resource.

6. The apparatus according to claim 1, wherein the relation information generating unit is configured to generate the second relation information in correspondence with each of a plurality of second information resources when the first information resource is generated based on the second information resources.

7. The apparatus according to claim 1, wherein the relation information generating unit is configured to automatically generate the first relation information and the second relation information using at least one of information indicating what action generates the first information resource from the second information resource, information provided by comparison of content of the second information resource with that of the first information resource, and information of caption concerning the second information resource included in the first information resource.

8. A relation information generating system according to claim 1, wherein the relation information generating unit comprises a correlation link generator including a plurality of comparison modules and a plurality of descriptive texts and a selector to select a comparison module from the comparison modules and a descriptive text from the descriptive texts according to the action to compare a content of the first information resource with a content of the second information resource, and generating a correlation link descriptive text describing a relation between the first information resource and the second information resource according to a comparison result, using the selected descriptive text.

9. A method for generating information indicating a relation between a plurality of information resources, the apparatus comprising:
detecting an action done by a user when the user creates or selects a first information resource of the plurality of information resources referring to at least one second information resource of the plurality of information resources;
generating first relation information and second relation information according to the detected action, the first relation information including a first descriptive text to explain a relation from the first information resource to the second information resource, and the second relation information including a second descriptive text to explain a relation from the second information resource to the first information resource; and
imparting the first relation information and the second relation information to the first information resource and the second information resource to correlate with each other.

10. The method according to claim 9, further comprising storing in a storage the first relation information and the second relation information correlating with the first information resource and the second relation information respectively.

11. The method according to claim 9, comprising selecting a template from a plurality of templates corresponding to a plurality of actions according to the detected action, and generating the first descriptive text and the second descriptive text using the selected template.

12. The method according to claim 9, wherein the first relation information includes an identifier indicating a location of storing the second information resource, and the second relation information includes an identifier indicating a location of storing the first information resource.

13. The method according to claim 9, further including generating the first descriptive text and the second descriptive text using at least one of contents of the action, information provided by comparison between the first information resource and the second information resource and a caption relating to the first information resource contained in the second information resource.

14. The method according to claim 9, further including generating the second relation information in correspondence with each of a plurality of second information resources when the first information resource is generated based on the second information resources.

15. The method according to claim 9, further including automatically generating the first relation information and the second relation information using at least one of information indicating what action generates the first information resource from the second information resource, information provided by comparison of content of the second information resource with that of the first information resource, and information of caption concerning the second information resource included in the first information resource.

16. The method according to claim 9, including selecting a comparison module from a plurality of comparison modules and a descriptive text from a plurality of descriptive texts according to the action, comparing a content of the first information resource with a content of the second information resource with the selected comparison module, and generating a correlation link descriptive text describing a relation between the first information resource and the second information resource according to a comparison result, using the selected descriptive text.

17. A computer readable medium storing a program for generating information indicating a relation between a plurality of information resources, the program comprising:
means for instructing a computer to detect an action done by a user when the user creates or selects a first information resource of the plurality of information resources referring to at least one second information resource of the plurality of information resources;
means for instructing the computer to generate first relation information and second relation information according to the detected action, the first relation information including a first descriptive text to explain a relation from the first information resource to the second information resource, and the second relation information including a second descriptive text to explain a relation from the second information resource to the first information resource; and
means for instructing the computer to impart the first relation information and the second relation information to the first information resource and the second information resource to correlate with each other.

18. The computer readable medium according to claim 17, wherein the program includes means for instructing the computer to select a template from a plurality of templates corresponding to a plurality of actions according to the detected action, and means for instructing the computer to generate the first descriptive text and the second descriptive text using the selected template.

19. The computer readable medium according to claim 17, wherein the program includes means for the computer to generate automatically the first relation information and the second relation information using at least one of information indicating what action generates the first information resource from the second information resource, information provided by comparison of content of the second information resource with that of the first information resource, and information of caption concerning the second information resource included in the first information resource.

20. The computer readable medium according to claim 17, wherein the program includes means for instructing the computer to select a comparison module from a plurality of comparison modules and a descriptive text from a plurality of descriptive texts according to the action, means for instructing the computer to compare a content of the first information resource with a content of the second information resource with the selected comparison module, and means for instructing the computer to generate a correlation link descriptive text describing a relation between the first information resource and the second information resource according to a comparison result, using the selected descriptive text.
